(19) United States
(12) Patent Application Publication
(10) Pub. No.: US 2026/0146870 A1
(43) Pub. Date: May 28, 2026

(54) METHOD FOR READING CONSUMPTION INFORMATION IN AN AUTOMATED SMART-METER MANAGEMENT SYSTEM

(71) Applicant: SAGEMCOM ENERGY & TELECOM SAS, Bois-Colombes (FR)

(72) Inventors: Henri TEBOULLE, Bois-Colombes (FR); Ziv ROTER, Bois-Colombes (FR)

(73) Assignee: SAGEMCOM ENERGY & TELECOM SAS, Bois-Colombes (FR)

(21) Appl. No.: 19/383,198

(22) Filed: Nov. 7, 2025

(30) Foreign Application Priority Data
Nov. 28, 2024 (FR) 2413161

(51) Int. Cl. G01D 4/00; B60L 53/66

(52) U.S. Cl. CPC G01D 4/002; B60L 53/66

(57) ABSTRACT

An automated management system includes a primary and secondary smart electricity meters, each primary smart electricity meter supervising a general electrical installation, each secondary smart electricity meter being connected downstream of a said primary smart electricity meter and supervising a dedicated electrical installation. The automated management system furthermore comprising a first information system managing the primary smart electricity meters and a second information system managing the secondary smart electricity meters. Each primary smart electricity meter collects information on electricity consumption of the general electrical installation, and each secondary smart electricity meter collects information on the electrical consumption of the dedicated electrical installation, to attribute the electricity consumption to a subscriber. Each secondary smart electricity meter collects intrinsic electricity-consumption information from the secondary smart electricity meter in question so that the first information system attributes this electricity consumption to the second information system.

### TECHNICAL FIELD

At least one embodiment relates to a method for reading electricity-consumption information in an automated smart-meter management system in which a secondary smart electricity meter, which is dedicated to a specific electrical installation, is connected to an electrical supply of a general electrical installation that is supervised by a primary smart electricity meter that serves as a relay for the secondary smart electricity meter in reading electricity-consumption information.

### PRIOR ART

Smart electricity meters are known which comprise long-range communication interfaces, such as cellular communication interfaces or powerline communication interfaces, enabling an automated management system to make a remote reading of consumption data. Consumption data can thus be transmitted, at regular intervals or on demand, to an information system IS processing them in a centralised manner. Sometimes a plurality of such information systems IS, typically belonging to separate operators, may share one and the same infrastructure for reading consumption information from these smart electricity meters.

There is a need, in a general electrical installation, to distinguish electricity consumption of a subpart of said general electrical installation that is dedicated to a specific usage, such as for example recharging electric vehicles, from the rest of the electricity consumption of said general electrical installation.

It is moreover desirable for the electricity consumption of this subpart of the general electrical installation to be able to be managed by an information system IS distinct from the one that manages the electricity consumption of the rest of said general electrical installation, since the specific usages may require specific subscriptions in order to manage the charge balance of the electrical network that supplies the electrical installation.

### DISCLOSURE OF THE INVENTION

For this purpose, a method is proposed here for reading electricity consumption in an automated management system comprising primary smart electricity meters and secondary smart electricity meters, each primary smart electricity meter supervising a general electrical installation, each secondary smart electricity meter being connected downstream of a said primary smart electricity meter and supervising a dedicated electrical installation that is a subpart of the general electrical installation supervised by the primary smart electricity meter in question, the automated management system furthermore comprising a first information system managing the primary smart electricity meters and a second information system managing the secondary smart electricity meters,
the method comprising the following steps, for each said general electricity installation that comprises a said primary smart electricity meter and a said secondary smart electricity meter and with which there is associated an electricity distribution subscription declared to the first information system and to the second information system:
the primary smart electricity meter collects information on electricity consumption of the general electrical installation, and transmits it to the first information system;
the secondary smart electricity meter collects information on electricity consumption of the dedicated electrical installation and information on the intrinsic electricity consumption of said secondary smart electricity meter, and transmits it to the primary smart electricity meter;
the primary smart electricity meter relays to the first information system and to the second information system the information on electricity consumption of the dedicated electrical installation and the information on the intrinsic electricity consumption of said secondary smart electricity meter;
the first information system subtracts, from the electricity consumption of the general electrical installation, the electricity consumption of the dedicated electrical installation and the intrinsic electricity consumption of the secondary smart electricity meter, and attributes the result thereof to the subscription;
the first information system attributes to the second information system the intrinsic electricity consumption of said secondary smart electricity meter; and
the second information system attributes to the subscription the electricity consumption of the dedicated electrical installation.

Thus each of the first and second information systems is in a position to manage its share of the charge on the electricity network, taking particularly into account the electricity consumption on the secondary smart electricity meter which must be taken into account by the second information system in the impact with regard to the charge on the electrical network but which is not attributable directly to the electricity consumption of the dedicated electrical installation (not attributable to the subscriber since it is distribution-infrastructure electricity consumption, which moreover exists even when the electrical supply of the dedicated installation is cut).

According to a particular embodiment, the first information system transmits to the second information system the information on the intrinsic electricity consumption of said secondary smart electricity meter.

Thus the second information system can verify the electricity consumption that is attributed to it by the first information system.

According to a particular embodiment, the first information system furthermore transmits to the second information system the information on the electricity consumption of the dedicated electrical installation.

Thus the second information system can verify the electricity consumption subtracted by the first information system from the electricity consumption of the general electrical installation.

According to a particular embodiment, the information on the intrinsic electricity consumption of said secondary smart electricity meter is obtained by measurements made by means of a shunt installed at the internal electrical supply input of said secondary smart electricity meter.

Thus the measurement of the intrinsic electrical consumption of said secondary smart electricity meter is precise and authenticated (metrological).

According to a particular embodiment, the information on the intrinsic electricity consumption of said secondary smart electricity meter is obtained by measurements made by means of a resistor installed at the internal electrical supply input of said secondary smart electricity meter.

Thus the measurement of the intrinsic electrical consumption of said secondary smart electricity meter is reliable.

According to a particular embodiment, the information on the intrinsic electricity consumption of said secondary smart electricity meter is obtained by reading a register, or a memory space, providing a predetermined estimation of the intrinsic electricity consumption of said secondary smart electricity meter.

Thus the intrinsic electricity consumption of said secondary smart electricity meter is easily determined.

According to a particular embodiment, said secondary smart electricity meter comprises a breaker for suspending and re-establishing the electrical supply of the dedicated electrical installation.

Thus the secondary smart electricity meters are adapted to dedicated electrical installations of various natures (electrical supply of heat pumps, recharging electric vehicles, etc).

According to a particular embodiment, the dedicated electrical installation comprises an electric-vehicle charger that is provided with a breaker remotely controllable by said secondary smart electricity meter for suspending and re-establishing the electrical supply of the dedicated electrical installation.

Thus the secondary smart electricity meters are adapted to electrical installations dedicated to the recharging of electric vehicles.

According to a particular embodiment, said secondary smart electricity meter comprises an electric-vehicle charger that is provided with a breaker internally controllable by said secondary smart electricity meter for suspending and re-establishing the electrical supply of the dedicated electrical installation.

Thus the secondary smart electricity meters are directly adapted to the recharging of electric vehicles.

An automated management system is also proposed here comprising primary smart electricity meters and secondary smart electricity meters, each primary smart electricity meter being configured to supervise a general electrical installation, each secondary smart electricity meter being connected downstream of a said primary smart electricity meter and being configured to supervise a dedicated electrical installation that is a subpart of the general electrical installation supervised by the primary smart electricity meter in question, the automated management system furthermore comprising a first information system managing the primary smart electricity meters and a second information system managing the secondary smart electricity meters,
the automated management system comprising electronic circuitry configured to implement the following steps, for each said general electricity installation that comprises a said primary smart electricity meter and a said secondary smart electricity meter and with which there is associated an electricity distribution subscription declared to the first information system and to the second information system:
the primary smart electricity meter collects information on electricity consumption of the general electrical installation, and transmits it to the first information system;
the secondary smart electricity meter collects information on electricity consumption of the dedicated electrical installation and information on the intrinsic electricity consumption of said secondary smart electricity meter, and transmits it to the primary smart electricity meter;
the primary smart electricity meter relays to the first information system and to the second information system the information on electricity consumption of the dedicated electrical installation and the information on the intrinsic electricity consumption of said secondary smart electricity meter;
the first information system subtracts, from the electricity consumption of the general electrical installation, the electricity consumption of the dedicated electrical installation and the intrinsic electricity consumption of the secondary smart electricity meter, and attributes the result thereof to the subscription;
the first information system attributes to the second information system the intrinsic electricity consumption of said secondary smart electricity meter; and
the second information system attributes to the subscription the electricity consumption of the dedicated electrical installation.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates schematically a system for the automated management of smart electricity meters in which the present invention can be implemented, in a first embodiment;

FIG. 2 illustrates schematically the system for the automated management of smart electricity meters, in a second embodiment;

FIG. 3 illustrates schematically the system for the automated management of smart electricity meters, in a third embodiment;

FIG. 4 illustrates schematically operations and exchanges occurring in the system for the automated management of smart electricity meters, in the first embodiment;

FIG. 5 illustrates schematically operations and exchanges occurring in the system for the automated management of smart electricity meters, in the second embodiment;

FIG. 6 illustrates schematically operations and exchanges occurring in the system for the automated management of smart electricity meters, in the third embodiment; and

FIG. 7 illustrates schematically an example of a hardware platform that can be used in the system for the automated management of smart electricity meters.

### DETAILED DISCLOSURE OF EMBODIMENTS

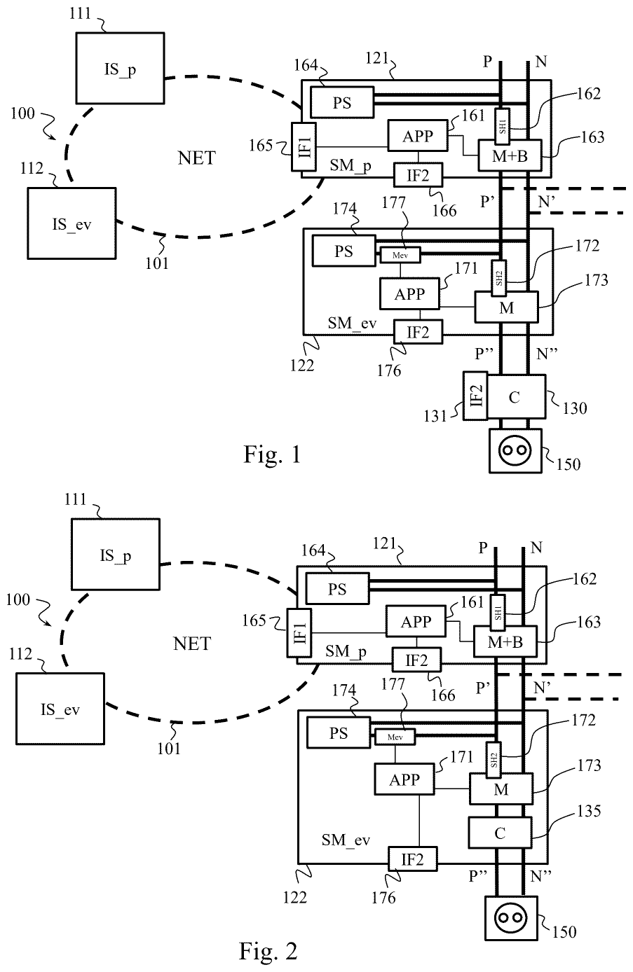

FIG. 1 illustrates schematically an automated management system 100 in which the present invention can be implemented. The automated management system 100 is configured to make a collection of electricity consumption data resulting from measurements made by smart electricity meters.

The automated management system 100 comprises smart electricity meters SM_p 121 of a first type, referred to as primary smart electricity meters. Each primary smart electricity meter SM_p 121 supervises the electricity distribution for an electrical installation to which one or more smart electricity meters 122 of a second type, referred to as secondary smart electricity meters, are potentially connected downstream of the primary smart electricity meter SM_p 121 with respect to the electrical network. These secondary smart electricity meters 122 therefore supervise the electricity distribution for a dedicated electrical installation, which is a subpart of a general electrical installation supervised by the primary smart electricity meter SM_p 121.

The secondary smart electricity meters 122 are thus dedicated to the supervision of electricity distribution for a specific use, for example a supply to a heat pump or recharging an electric vehicle. These secondary smart electricity meters 122 are sometimes referred to as “dedicated metering devices” DMD. It is considered preferentially hereinafter that the secondary smart electricity meters 122 are dedicated to the supervision of electricity distribution for recharging electric vehicles.

The secondary smart electricity meters 122 and the primary smart electricity meters SM_p 121 are managed remotely by respective distinct information systems IS. On the diagram in FIG. 1, the primary smart electricity meters SM_p 121 are managed remotely by an information system IS_p 111 and the secondary smart electricity meters SM_ev 122 are managed remotely by an information system IS_ev 112.

Each electrical installation is associated with a subscription that defines conditions for electricity distribution to said electrical installation, for example authorised power limits or specific conditions for electricity distribution in certain time ranges. When the electrical installation is equipped with a said primary smart electricity meter SM_p 121 and with a said secondary smart electricity meter SM_ev 122, a first part of the subscription (or a first subscription) is managed by the information system IS_p 111 and a second part of the subscription (or a second subscription) is managed by the information system IS_ev 112.

In one and the same electrical installation at a subscriber, the primary smart electricity meter SM_p 121 is installed in advance, typically by an agent of a first electricity supplier, directly at the Phase P/Neutral N electrical incoming cable on the electrical network side, and the secondary smart electricity meter SM_ev 122 dedicated to electric-vehicle recharging is installed subsequently, potentially by an agent of a second electricity supplier, on a Phase P′/Neutral N′ electricity supply at the output of the primary smart electricity meter SM_p 121. The secondary smart electricity meter SM_ev 122 is typically installed at a distance from the primary smart electricity meter SM_p 121 that makes it possible to put in communication the primary smart electricity meter SM_p 121 and the secondary smart electricity meter SM_ev 122 by means of respective communication interfaces IF2 166, 176. Since the primary smart electricity meter SM_p 121 and the secondary smart electricity meter SM_ev 122 are typically installed in proximity to each other, the communication interfaces IF2 166, 176 are adapted and configured to establish a short-range communication link, for example in accordance with the M-Bus (“Meter Bus”) remote-reading specifications as defined in EN 13757-2 or in accordance with the wM-Bus (“Wireless M-Bus”) specifications as defined in EN 13757-4. Other short-range communication technologies can be used, such as Bluetooth, Wi-Fi, Zigbee, KNX, KNX-RF, RS485 etc. A pairing between the primary smart electricity meter SM_p 121 and the secondary smart electricity meter SM_ev 122 is preferentially implemented at the time of commissioning of the secondary smart electricity meter SM_ev 122.

At the output of the secondary smart electricity meter SM_ev 122, a Phase P″/Neutral N″ electrical supply electrically supplies said dedicated electrical installation. In the case of FIG. 1, the dedicated electrical installation comprises an electrical connector 150 connected to the Phase P″/Neutral N″ electrical supply at the output of the secondary smart electricity meter SM_ev 122 by means of a charger C 130 adapted to recharging the electric vehicle. The charger C 130 then comprises a controllable breaker for selectively enabling or inhibiting the electrical supply to the electrical connector 150.

It should be noted that the primary smart electricity meter SM_p 121 may be a polyphase meter and the secondary smart electricity meter SM_ev 122 a monophase meter then supplied by only one of the electrical supply phases provided by the primary smart electricity meter SM_p 121.

On the diagram in FIG. 1, the communication interface IF2 176 of the secondary smart electricity meter SM_ev 122 is also adapted and configured to communicate with the charger C 130. Conversely, the charger C 130 comprises a communication interface IF2 131 adapted and configured to communicate with the secondary smart electricity meter SM_ev 122 in question. This makes it possible in particular for the secondary smart electricity meter SM_ev 122 to remotely control actions on the breaker of the charger C 130. A pairing between the secondary smart electricity meter SM_ev 122 and the charger C 130 is preferentially implemented at the time of commissioning of the secondary smart electricity meter SM_ev 122 and of the charger C 130.

The information system IS_p 111 is centralised management equipment and the primary smart electricity meters SM_p 121 are registered with the information system IS_p 111, in accordance with subscriptions taken out by respective users (subscribers) with a distributor (an operator supplying electricity) for which the information system IS_p 111 operates.

The remote management of the primary smart electricity meters SM_p 121 by the information system IS_p 111, and in particular the reading of electricity consumption information, takes place through a communication network NET 101. To do this, each primary smart electricity meter SM_p 121 has a communication interface IF1 165 adapted and configured to communicate via the communication network NET 101.

The information system IS_ev 112 is centralised management equipment and the secondary smart electricity meters SM_ev 122 are registered with the information system IS_ev 112, in accordance with subscriptions taken out by respective users (subscribers) with a distributor (an operator supplying electricity) for which the information system IS_ev 112 operates.

The remote management of each secondary smart electricity meter SM_ev 122 by the information system IS_ev 112 is implemented using as relay the primary smart electricity meter SM_p 121 of the general electrical installation to which the secondary smart electricity meter SM_ev 122 in question is connected. This makes it possible to avoid the secondary smart electricity meters SM_ev 122 having to incorporate a communication interface IF1 adapted and configured to communicate via the communication network NET 101, and this limits the number of smart electricity meters connected to the communication network NET 101 and therefore simplifies the management of the accesses to the communication network NET 101.

For example, the communication network NET 101 is a wireless communication network of the 5G (5 th Generation) type. According to other examples, the communication network NET 101 is a wireless communication network of the following types: GPRS (“General Packet Radio Service”), UMTS (“Universal Mobile Telecommunication System”), LTE-MTC (“ Long-Term Evolution Machine Type Communication”), also known by the diminutive LTE-M, or NB-IoT (“NarrowBand Internet of Things”). According to yet another example, the communication network NET 101 is a powerline communication PLC network, for example conforming to the PRIME or G3-PLC standard.

For example, each information system IS_p 111, IS_ev 112 comprises various components including a head-end system HES, a meter data management system MDMS, and a key management system KMS. The head-end system HES is configured to implement the management of transmissions in the context of the remote management of smart electricity meters, and in particular in the context of consumption data collection. The meter data management system MDMS is configured to process the consumption data collected. The key management system KMS is configured to store encryption keys that would be necessary for the meter data management system MDMS and for the smart electricity meters, as well as for any intermediate equipment between the information system IS_p 111, IS_ev 112 and the smart electricity meters in question, such as for example a gateway or a data concentrator. The components of the information system IS_p 111, IS_ev 112 communicate with each other for example using the internet, or more generally a network of the IP (“Internet Protocol”) type, or potentially using a Virtual Private Network VPN.

Each primary smart electricity meter SM_p 121 comprises an internal power supply device PS 164 used for electrically supplying, from the Phase P and Neutral N, elements internal to the primary smart electricity meter SM_p 121. Apart from the communication interface IF1 165 and the communication interface IF2 166, these internal elements of the primary smart electricity meter SM_p 121 include an application function APP 161, for example executed by a processor provided with a memory or implemented by a dedicated electronic component, configured to control the primary smart electricity meter SM_p 121, in particular in the context of reading electricity consumption information. The internal elements of the primary smart electricity meter SM_p 121 furthermore include a metrology function equipped with a breaker 163 (denoted M+B in FIG. 1) that makes measurements of electricity consumption of the general electrical installation supervised by the primary smart electricity meter SM_p 121 in question. The breaker of the primary smart electricity meter SM_p 121 enables the information system IS_p 111 to selectively enable or inhibit the electrical supply to the general electrical installation supervised by the primary smart electricity meter SM_p 121.

The electricity consumption of the general electrical installation is measured by means of a shunt SH1 162 installed at the input of the primary smart electricity meter SM_p 121 (Phase P, after the power connector of the internal power supply device PS 164 of said primary smart electricity meter SM_p 121), and voltage measurements at its terminals make it possible to obtain a precise and authenticated indication of the electricity consumption of the general electrical installation. No measurement of intrinsic electricity consumption of the primary smart electricity meter SM_p 121 is necessary since the consumption measurement by means of the shunt SH1 162 does not take into account the electricity consumption of the internal elements of the primary smart electricity meter SM_p 121.

Each secondary smart electricity meter SM_ev 122 comprises an internal power supply device PS 174 used for electrically supplying, from the Phase P′ and Neutral N′, elements internal to the secondary smart electricity meter SM_ev 122. Apart from the communication interface IF2 176, these internal elements of the secondary smart electricity meter SM_ev 122 include an application function APP 171, for example executed by a processor provided with a memory or implemented by a dedicated electronic component, configured to control the secondary smart electricity meter SM_ev 122, in particular in the context of reading electricity consumption information. The internal elements of the secondary smart electricity meter SM_ev 122 furthermore include a metrology function 173 (denoted M in FIG. 1) that makes measurements of electricity consumption of the dedicated electrical installation that is supervised by the secondary smart electricity meter SM_ev 122 in question. No breaker is here necessary to the secondary smart electricity meter SM_ev 122, since the charger C 130 is itself provided with such a breaker.

The electricity consumption of the dedicated electrical installation is measured by means of a shunt SH 2 172 installed at the input of the secondary smart electricity meter SM_ev 122 (Phase P', after the power connector of the internal power supply device PS 174 of said secondary smart electricity meter SM_ev 122), and voltage measurements at its terminals make it possible to obtain a precise and authenticated indication of the electricity consumption of the dedicated electrical installation.

Each secondary smart electricity meter SM_ev 122 furthermore comprises a device Mev 177 for supplying data on the intrinsic electricity consumption of the secondary smart electricity meter SM_ev 122. In a particular embodiment, the device Mev 177 is a shunt installed at the input of the internal electrical supply PS 174 of the secondary smart electricity meter SM_ev 122, and voltage measurements at its terminals make it possible to obtain a precise and authenticated indication of the intrinsic electricity consumption of the secondary smart electricity meter SM_ev 122. In another particular embodiment, the device Mev 177 is a resistor installed at the input of the internal electrical supply PS 174 of the secondary smart electricity meter SM_ev 122, and voltage measurements at its terminals make it possible to obtain a reliable indication of the intrinsic electricity consumption of the secondary smart electricity meter SM_ev 122. In another particular embodiment, the device Mev 177 is a register, or a memory space, providing a predetermined estimation (for example measured in the laboratory) of the intrinsic electricity consumption of the secondary smart electricity meter SM_ev 122.

FIG. 2 illustrates schematically an automated management system 100 in another embodiment.

In the case of FIG. 2, the charger C (referenced 135 in FIG. 2) is incorporated in the secondary smart electricity meter SM_ev 122, downstream of the metrology function M 173. This is because, unlike the smart electricity meters, the charger C 135 does not form part of the electricity distribution infrastructure that is the responsibility of the energy suppliers, and the electricity consumption thereof forms part of the electricity consumption of the dedicated electrical installation. It is therefore not necessary for the charger C 135 to have available the communication interface IF2, since the charger C 135 is then controlled internally to the secondary smart electricity meter SM_ev 122. The secondary smart electricity meter SM_ev 122 does here however also have available the communication interface IF2 176 in order to be able to communicate with the primary smart electricity meter SM_p 121 concerned.

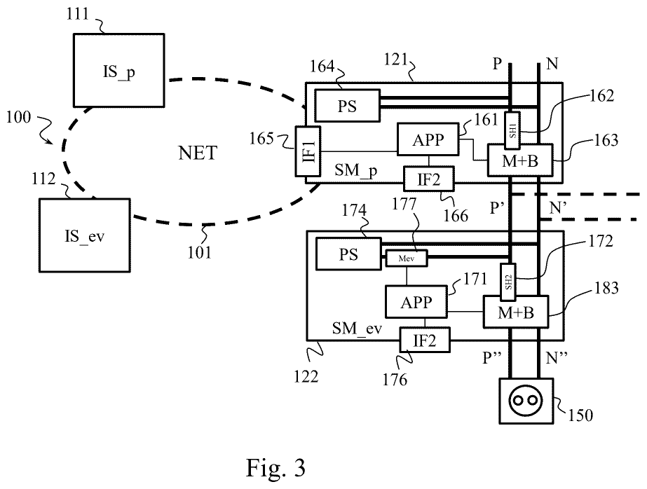

FIG. 3 illustrates schematically an automated management system 100 in another embodiment.

In the case of FIG. 3, the charger C 130 is absent and the electrical connector 150 is directly connected to the Phase P″/Neutral N″ electrical supply at the output of the secondary smart electricity meter SM_ev 122. The secondary smart electricity meter SM_ev 122 does here however also have available the communication interface IF2 176 in order to be able to communicate with the primary smart electricity meter SM_p 121 concerned. The secondary smart electricity meter SM_ev 122 is then equipped with a breaker. In other words, the metrology function 173 of FIG. 1 and of FIG. 2 is replaced by a metrology function equipped with a breaker 183 (denoted M+B in FIG. 3).

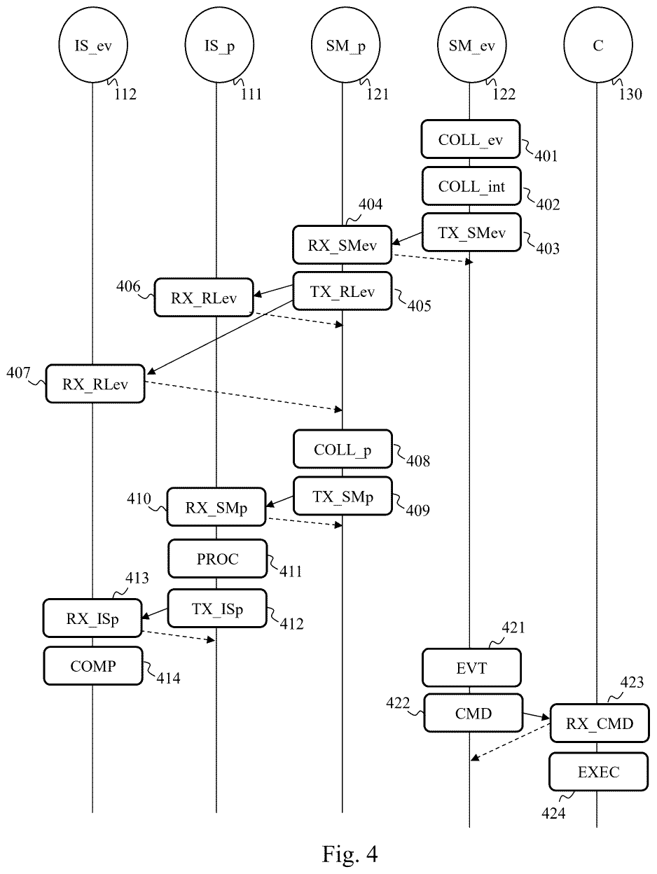

FIG. 4 illustrates schematically operations and exchanges occurring in the automated management system 100, in the embodiment in FIG. 1. The operations and exchanges in FIG. 4 make it possible in particular to read electricity consumption information, and are for example performed daily.

In a step 401 (denoted COLL_ev in FIG. 4), the secondary smart electricity meter SM_ev 122 collects information on the electricity consumption of the dedicated electrical installation (consumption index, consumption charge curve). The secondary smart electricity meter SM_ev 122 can furthermore collect electricity production information from the dedicated electrical installation (production index, production charge curve), for example when an electric vehicle supplies, via the dedicated electrical installation, energy stored on the battery.

In a step 402 (denoted COLL_int in FIG. 4), the secondary smart electricity meter SM_ev 122 collects information on the intrinsic electricity consumption from the secondary smart electricity meter SM_ev 122 (consumption index, consumption charge curve).

In a step 403 (denoted TX_SMev in FIG. 4), the secondary smart electricity meter SM_ev 122 transmits the electricity consumption information collected at the steps 401 and 402. This electricity consumption information is transmitted to the primary smart electricity meter SM_p 121 (which supervises the general electrical installation to which the secondary smart electricity meter SM_ev 122 is connected), which receives it in a step 404 (denoted RX_SMev in FIG. 4). As illustrated schematically by a broken arrow in FIG. 4 at the start of the step 404, the primary smart electricity meter SM_p 121 can send an acknowledgement in response to the electricity consumption information received from the secondary smart electricity meter SM_ev 122.

The primary smart electricity meter SM_p 121 then relays the electricity consumption information, which is received from the secondary smart electricity meter SM_ev 122, to the information system IS_ev 112 and the information system IS_p 111, in a step 405 (denoted TX_RLev in FIG. 4). This relayed electricity consumption information is thus, firstly, transmitted to the information system IS_ev 112, which receives it in a step 407 (denoted RX_RLev in FIG. 4). This electricity consumption information is, secondly, transmitted to the information system IS_p 111, which receives it in a step 406 (also denoted RX_RLev in FIG. 4). As illustrated schematically by the broken arrows in FIG. 4 at the start of the steps 406 and 407, the information system IS_ev 112 and the information system IS_p 111 can send an acknowledgement in response to the electricity consumption information relayed by the primary smart electricity meter SM_p 121.

On reception, the information system IS_p 111 attributes to the information system IS_ev 112 the intrinsic electricity consumption of the secondary smart electricity meter SM_ev 122.

In addition, on reception, the information system IS_ev 112 attributes to the subscription concerned the electricity consumption of the dedicated electrical installation in its management of the charging of the electrical network. The information system IS_ev 112 furthermore knows what electricity consumption will be attributed to it by the information system IS_p 111 in the management of the charging of the electrical network, i.e. the intrinsic electricity consumption of the secondary smart electricity meter SM_ev 122.

In a step 408 (denoted COLL_p in FIG. 4), the primary smart electricity meter SM_p 121 collects information on electricity consumption of the general electrical installation.

In a step 409 (denoted TX_SMp in FIG. 4), the primary smart electricity meter SM_p 121 transmits to the information system IS_p 111 the electricity consumption information collected at the step 408. The information system IS_p 111 receives this information on electricity consumption of the general electrical installation in a step 410 (denoted RX_SMp in FIG. 4). As illustrated schematically by a broken arrow in FIG. 4 at the start of the step 410, the information system IS_p 111 can send an acknowledgement in response to the electricity consumption information received from the primary smart electricity meter SM_p 121.

In a step 411 (denoted PROC in FIG. 4), the information system IS_p 111 implements processing on the consumption information received at the steps 406 and 410. More particularly, the information system IS_p 111 subtracts, from the electricity consumption indicated in the information received at the step 410, the electricity consumption indicated in the information received at the step 406, including the intrinsic electricity consumption of the secondary smart electricity meter SM_ev 122. The information system IS_p 111 thus determines the electricity consumption of the general electrical installation apart from the dedicated electrical installation, and attributes it to the subscription concerned in its management of the charge for the electricity network.

It should be noted that the information system IS_p 111 could receive the electricity consumption information coming from the primary smart electricity meter SM_p 121 before receiving the information coming from the secondary smart electricity meter SM_ev 122 as relayed by the primary smart electricity meter SM_p 121.

In a step 412 (denoted TX_ISp in FIG. 4), the information system IS_p 111 transmits to the information system IS_ev 112 the information on the intrinsic electricity consumption of the secondary smart electricity meter SM_ev 122 received at the step 406. In a variant, the information system IS_p 111 transmits, to the information system IS_ev 112, all the electricity consumption information received at the step 406. The information system IS_ev 112 receives this electricity consumption information in a step 413 (denoted RX_ISp in FIG. 4). As illustrated schematically by a broken arrow in FIG. 4 at the start of the step 413, the information system IS_ev 112 can send an acknowledgement in response to the electricity consumption information received from the smart electricity meter IS_p 111.

Thus, in a step 414 (denoted COMP in FIG. 4), the information system IS_ev 112 compares the electricity consumption information received at the step 407 from the secondary smart electricity meter SM_ev 122 and the electricity consumption information received at the step 413 from the information system IS_p 111. The information system IS_ev 112 can thus verify the share of the electricity consumption that is attributed to it by the information system IS_p 111. If by chance the items of electricity consumption information received at the steps 407 and 413 proved to be inconsistent with each other, the information system IS_ev 112 would establish a thorough checking procedure, for example by triggering a request for action at the subscriber in question in order to check on site the electricity consumption information and/or the correct operation of the secondary smart electricity meter SM_ev 122.

Thus, by virtue of the operations and exchanges described above, each of the information systems IS_p 111 and IS_ev 112 is in a position to manage its share of charge on the electricity network. These operations and exchanges take particularly into account the electricity consumption of the secondary smart electricity meter SM_ev 122 that must be taken into account by the information system IS_ev 112 in the impact with regard to the charge on the electrical network but which is not attributable directly to the electricity consumption of the dedicated electrical installation (not ascribable to the subscriber since it is electricity consumption of the electricity distribution network that is the responsibility of the energy suppliers, which moreover exists even when the electrical supply of the dedicated installation is cut).

In the context of the management of the charge on the electricity network, the electrical supply to the dedicated electrical installation may be caused to be cut during a time period, referred to as a suspension period, at the end of which the electrical supply to the dedicated electrical installation is re-established. The breaker of the charger C 130 is used for this purpose under the control of the secondary smart electricity meter SM_ev 122, optionally on instruction from the information system IS_ev 112. Thus, in a step 421 (denoted EVT in FIG. 4), the secondary smart electricity meter SM_ev 122 detects the occurrence of an event (e.g. start or end of a suspension period) requiring the actuation of the breaker of the charger C 130. The start of the suspension period follows for example an exceeding of power delivered to the dedicated electrical installation compared with the power authorised by the information system IS_ev 112 with regard to a charge balance on the electricity network. According to another example, the start of the suspension period follows the detection of entering a time range during which the dedicated electrical installation is not authorised by the information system IS_ev 112 to charge the electrical network with regard to the charge balance on the electricity network.

Then, in a step 422 (denoted CMD in FIG. 4), the secondary smart electricity meter SM_ev 122 transmits to the charger C 130 a command instructing the charger C 130 to actuate its breaker (opening or closing depending on whether it is the start or end respectively of the suspension period). The charger C 130 receives the command in a step 423 (denoted RX_CMD in FIG. 4). As illustrated schematically by a broken arrow in FIG. 3 at the start of the step 423, the charger C 130 can send an acknowledgement in response to the command. And, in a step 424 (denoted EXEC in FIG. 4, the charger C 130 executes the command in accordance with the instructions of the secondary smart electricity meter SM_ev 122.

It should be noted that, during the suspension period, the secondary smart electricity meter SM_ev 122 continues to operate (as long as the primary smart electricity meter SM_p 121 continues to supply it electrically) and the intrinsic electricity consumption of the secondary smart electricity meter SM_ev 122 persists. Account must be taken of this in the charge balance of the electricity network.

In a particular embodiment, the exchanges described above in relation to FIG. 4 conform to the DLMS specifications (“Device Language Message Specification”), and if applicable with the COSEM specifications (“Companion Specification for Energy Metering”). In a variant, the exchanges described above conform to the standard ANSI C12.22/ IEEE Std 1703.

In a particular embodiment, the readings of electricity consumption information are made with an asymmetric encryption of said electricity-consumption information in order to ensure non-repudiation thereof. The asymmetric encryption comprises a private signature key, for example generated from the serial number of the smart electricity meter in question. A public signature key is associated with a private signature key, the public signature key being known to the information system IS for which the electricity consumption information is intended, more particularly to the key management system KMS of the information system IS in question. To construct a message in encrypted form, a smart electricity meter applies a hash function to a first doublet formed by the serial number of the smart meter in question and electricity consumption information to be transmitted, and encrypts the result by means of its private signature key. A second doublet is next formed by juxtaposing the electricity consumption information to be transmitted and the result encrypted by means of the private signature key, and this second doublet is transmitted to the information system IS for which the electricity consumption information is intended, more particularly to the meter data management system MDMS of the information system IS in question. On reception, the information system IS recovers the electricity consumption information received and applies a hash function to a doublet formed by the serial number of the smart meter in question and by the electricity consumption information. The information system IS also applies the public signature key corresponding to the smart electricity meter in question to the encrypted part of the message received in order to decrypt it. By checking that the result of the hash function and the results of the decryption correspond, the information system IS can check that the information comes from the expected smart electricity meter and that this information has not been altered en route.

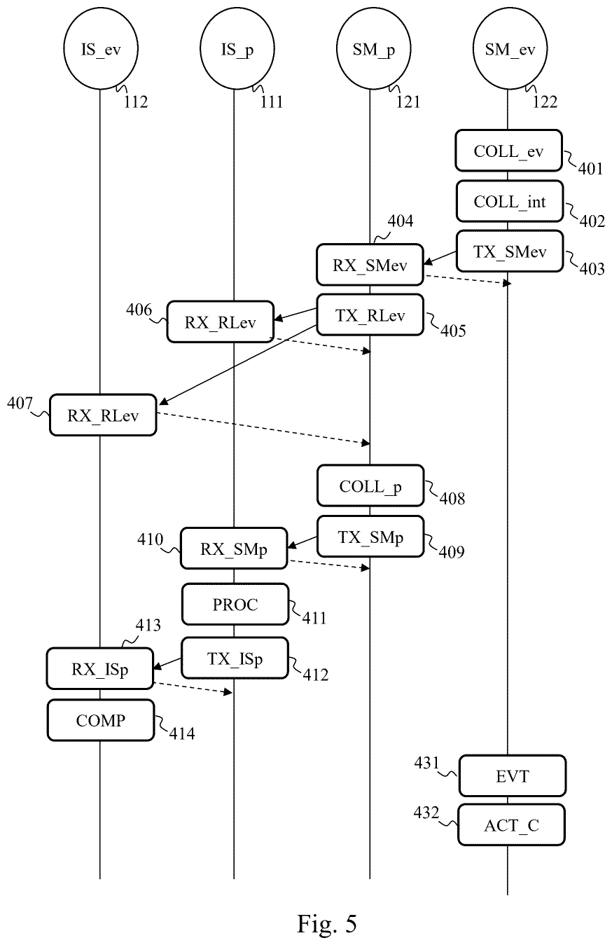

FIG. 5 illustrates schematically operations and exchanges occurring in the automated management system 100, in the embodiment in FIG. 2.

Thus, FIG. 5 repeats the operations and exchanges of the steps 401 to 414 detailed above in relation to FIG. 4.

As in the context of the operations and exchanges in FIG. 4, the electrical supply to the dedicated electrical installation may be caused to be cut during a time period, referred to as a suspension period, at the end of which the electrical supply to the dedicated electrical installation is re-established. The breaker of the charger C 135 incorporated in the secondary smart electricity meter SM_ev 122 is used for this purpose, optionally on instruction from the information system IS_ev 112. Thus, in a step 431 (denoted EVT in FIG. 5), the secondary smart electricity meter SM_ev 122 detects the occurrence of the event requiring the actuation of the breaker of the charger C 135. And, in a step 432 (denoted ACT_C in FIG. 5), the secondary smart electricity meter SM_ev 122 internally instructs the charger C 135 to actuate its breaker (opening or closing depending on whether it is the start or end respectively of the suspension period). It should also be noted here that, during the suspension period, the secondary smart electricity meter SM_ev 122 continues to operate (as long as the primary smart electricity meter SM_p 121 continues to supply it electrically) and the intrinsic electricity consumption of the secondary smart electricity meter SM_ev 122 persists.

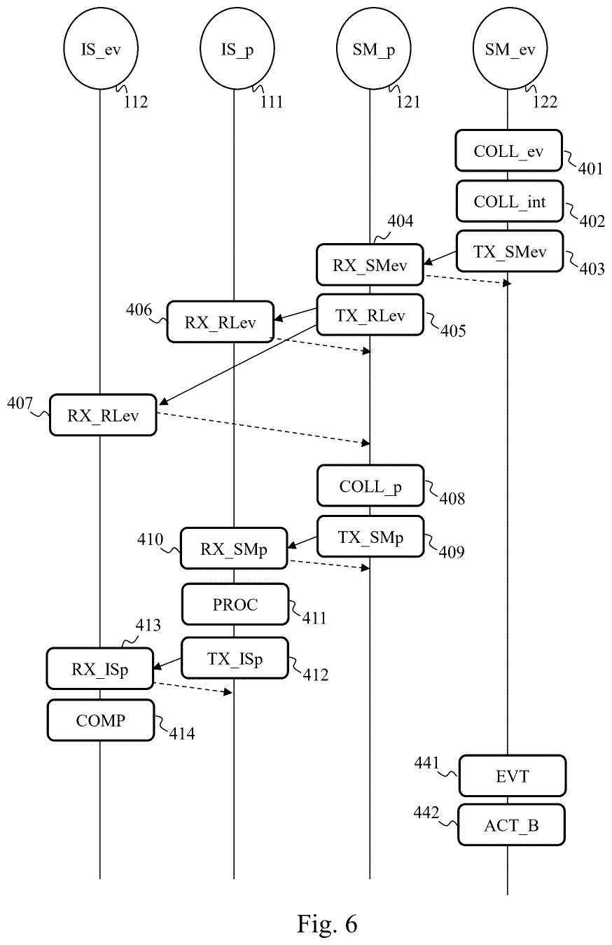

FIG. 6 illustrates schematically operations and exchanges occurring in the automated management system 100, in the embodiment in FIG. 3.

Unlike the embodiments in FIGS. 1 and 2, the embodiments in FIG. 3 does not comprise the charger C 130 or 135, and a breaker is included in the secondary smart electricity meter SM_ev 122.

Thus, FIG. 6 repeats the operations and exchanges of the steps 401 to 414 detailed above in relation to FIG. 4.

As in the context of the operations and exchanges in FIG. 4, the electrical supply to the dedicated electrical installation may be caused to be cut during a time period, referred to as a suspension period, at the end of which the electrical supply to the dedicated electrical installation is re-established. The breaker of the secondary smart electricity meter SM_ev 122 is used for this purpose, optionally on instruction from the information system IS_ev 112. Thus, in a step 441 (denoted EVT in FIG. 6), the secondary smart electricity meter SM_ev 122 detects the occurrence of the event requiring the actuation of its breaker. And, in a step 442 (denoted ACT_B in FIG. 6), the secondary smart electricity meter SM_ev 122 executes a command to actuate its internal breaker (opening or closing depending on whether it is the start or end respectively of the suspension period). It should also be noted here that, during the suspension period, the secondary smart electricity meter SM_ev 122 continues to operate (as long as the primary smart electricity meter SM_p 121 continues to supply it electrically) and the intrinsic electricity consumption of the secondary smart electricity meter SM_ev 122 persists.

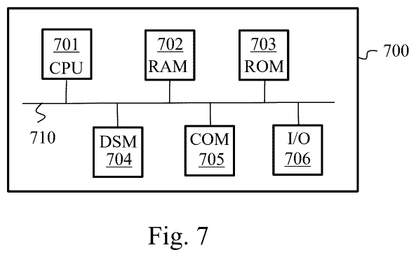

FIG. 7 illustrates schematically an example of a hardware platform 700 that can be used in the automated management system 100. The example of hardware architecture is thus adapted to implement a controller of the information system IS, or of any component of the information system IS. The example of hardware architecture is also adapted to implement a smart-meter controller, typically to implement the application functions APP 161, 171. The example of hardware architecture is also adapted to implement a controller of the charger C 130 or 135.

The hardware platform 700 then comprises, connected by a communication bus 710: a processor or CPU (“Central Processing Unit”) 701; a random access memory RAM 702; a read-only memory ROM 703, or EEPROM (“Electrically Erasable Programmable ROM”), or a flash memory; a data storage medium DSM 704, such as a hard disk drive HDD, or a storage medium reader, such as an SD (“Secure Digital”) card reader; and at least one communication interface COM 705. According to the device or equipment in question, the hardware platform 700 may further comprise inputs/outputs I/O 706, for example to make electricity consumption measurements.

The processor 701 is capable of executing instructions loaded in the RAM 702 from the ROM 703, from an external memory (not shown), from a storage medium such as an SD card, or from a communication network. When the hardware platform 500 is powered up, the processor 701 is capable of reading instructions from the RAM 702 and executing them. These instructions form a computer program causing an implementation, by the processor 701, of the steps, operations and exchanges described here in relation to the device or equipment concerned.

All or some of the steps, operations and exchanges described here can thus be implemented in software form by executing a set of instructions by a programmable machine, such as a DSP (“digital signal processor”) or a microcontroller, or be implemented in hardware form by a machine or a component (“chip”) or a set of components (“chipset”), such as an FPGA (“field-programmable gate array”) or an ASIC (“application-specific integrated circuit”). In general terms, each device or item of equipment of the automated management system 100 comprises electronic circuitry arranged and configured to implement the steps, operations and exchanges described here in relation to the device or equipment in question.

1. A method for reading electricity consumption in an automated management system comprising primary smart electricity meters and secondary smart electricity meters, each primary smart electricity meter supervising a general electrical installation, each secondary smart electricity meter being connected downstream of a said primary smart electricity meter and supervising a dedicated electrical installation that is a subpart of the general electrical installation supervised by the primary smart electricity meter in question, the automated management system furthermore comprising a first information system managing the primary smart electricity meters and a second information system managing the secondary smart electricity meters the method comprising the following steps, for each said general electricity installation that comprises a said primary smart electricity meter and a said secondary smart electricity meter and with which there is associated an electricity distribution subscription declared to the first information system and to the second information system:
the primary smart electricity meter collects information on electricity consumption of the general electrical installation, and transmits it to the first information system;
the secondary smart electricity meter collects information on electricity consumption of the dedicated electrical installation and information on the intrinsic electricity consumption of said secondary smart electricity meter and transmits (403) it to the primary smart electricity meter;
the primary smart electricity meter relays to the first information system and to the second information system the information on electricity consumption of the dedicated electrical installation and the information on the intrinsic electricity consumption of said secondary smart electricity meter
the first information system subtracts, from the electricity consumption of the general electrical installation, the electricity consumption of the dedicated electrical installation and the intrinsic electricity consumption of the secondary smart electricity meter, and attributes the result thereof to the subscription;
the first information system attributes to the second information system the intrinsic electricity consumption of said secondary smart electricity meter; and
the second information system attributes to the subscription the electricity consumption of the dedicated electrical installation.

2. The method according to claim 1, wherein the first information system transmits to the second information system the information on the intrinsic electricity consumption of said secondary smart electricity meter.

3. The method according to claim 2, wherein the first information system furthermore transmits to the second information system the information on the electricity consumption of the dedicated electrical installation.

4. The method according to claim 1, wherein the information on the intrinsic electricity consumption of said secondary smart electricity meter is obtained by measurements made by means of a shunt installed at the internal electrical supply input of said secondary smart electricity meter

5. The method according to claim 1, wherein the information on the intrinsic electricity consumption of said secondary smart electricity meter is obtained by measurements made by means of a resistor installed at the internal electrical supply input of said secondary smart electricity meter

6. The method according to claim 1, wherein the information on the intrinsic electricity consumption of said secondary smart electricity meter is obtained by reading a register, or a memory space, providing a predetermined estimation of the intrinsic electricity consumption of said secondary smart electricity meter

7. The method according to claim 1, wherein said secondary smart electricity meter comprises a breaker for suspending and re-establishing the electrical supply of the dedicated electrical installation.

8. The method according to claim 1, wherein the dedicated electrical installation comprises an electric-vehicle charger that is provided with a breaker remotely controllable by said secondary smart electricity meter for suspending and re-establishing the electrical supply of the dedicated electrical installation.

9. The Method according to claim 1, wherein said secondary smart electricity meter comprises an electric-vehicle charger that is provided with a breaker internally controllable by said secondary smart electricity meter for suspending and re-establishing the electrical supply of the dedicated electrical installation.

10. Automated management system comprising primary smart electricity meters and secondary smart electricity meters, each primary smart electricity meter being configured to supervise a general electrical installation, each secondary smart electricity meter being connected downstream of a said primary smart electricity meter and being configured to supervise a dedicated electrical installation that is a subpart of the general electrical installation supervised by the primary smart electricity meter in question, the automated management system furthermore comprising a first information system managing the primary smart electricity meters and a second information system managing the secondary smart electricity meters
the automated management system comprising electronic circuitry configured to implement the following steps, for each said general electricity installation that comprises a said primary smart electricity meter and a said secondary smart electricity meter and with which there is associated an electricity distribution subscription declared to the first information system and to the second information system:
the primary smart electricity meter collects information on electricity consumption of the general electrical installation, and transmits it to the first information system;
the secondary smart electricity meter collects information on electricity consumption of the dedicated electrical installation and information on the intrinsic electricity consumption of said secondary smart electricity meter and transmits it to the primary smart electricity meter
the primary smart electricity meter relays to the first information system and to the second information system the information on electricity consumption of the dedicated electrical installation and the information on the intrinsic electricity consumption of said secondary smart electricity meter; p1 the first information system subtracts from the electricity consumption of the general electrical installation, the electricity consumption of the dedicated electrical installation and the intrinsic electricity consumption of the secondary smart electricity meter and attributes the result thereof to the subscription;
the first information system attributes to the second information system the intrinsic electricity consumption of information on intrinsic electricity consumption of said secondary smart electricity meter; and
the second information system attributes to the subscription the electricity consumption of the dedicated electrical installation.
